(19) United States
(12) Patent Application Publication
(10) Pub. No.: US 2003/0067909 A1
(43) Pub. Date: Apr. 10, 2003

(54) Method and apparatus for setting up a communications link

(76) Inventors: Belhassen Jerbi, Muenchen (DE); Andreas Schmidt, Braunschweig (DE); Sabine Van Niekerk, Salzgitter (DE); Josef Laumen, Hildesheim (DE); Markus Trauberg, Velchede (DE)

Correspondence Address: Bell, Boyd & Lloyd LLC, P.O. Box 1135, Chicago, IL, 60690, US

(21) Appl. No.: 10/217,377

(22) Filed: Aug. 12, 2002

(30) Foreign Application Priority Data
Aug. 13, 2001 (DE) 101 397 45.3

(51) Int. Cl. H04L 12/66

(52) U.S. Cl. 370/352

(57) ABSTRACT

A method is provided for setting up a communications link between a first terminal, which is connected to a network based on an Internet protocol, and a second terminal, which is likewise connected to a network based on an Internet protocol. The method involves connecting a storage medium on which the IP address of the second terminal is stored to the first terminal. The storage medium then reads in the IP address of the second terminal, and finally a communications link is set up from the first terminal to the second terminal over the network using the IP address which has been read. By virtue of the IP addresses of a user's terminals being stored in the storage medium, the user merely needs to insert the storage medium into one of the terminals in order to set up a communications link between two of his/her terminals, the IP address of the further terminal being automatically read out for the communications link without the user needing to remember one of the IP addresses.

### BACKGROUND OF THE INVENTION

The present invention relates to a method for setting up a communications link, and to a storage medium and a terminal for implementing the method.

In past years, the Internet has been adopted to an ever increasing degree as a medium for transferring data of any format and content. This also involves working toward merging mobile communication in words and every other form of data on the basis of all standards; for example, in order to be able to transmit multimedia messages (MM) using a multimedia messaging service (MMS). This also provides mobile radios with Internet access in addition to their mobile voice transmission.

In a communications system, such as the Internet, every host and every router has its own address based on the Internet protocol, the “IP address”, which now needs to be processed and/or managed in addition to the known identifiers for a mobile radio link. The IP address (Internet protocol address) contains a network number and a host number in coded form. A particular combination is unique, or has a one-to-one association, as an IP address. That is to say, no two hosts or routers can exist which have the same IP address.

According to version 4 of the Internet protocol standard (IPv4), the IP address includes a 32-bit or 4-byte address field. This address can be divided up into two parts:

a network part denoting the network to which the host belongs; and

a host part identifying the host itself.

Hosts connected to the same network need to have the same part for identifying the network, but differ from one another by different bits in the respective host part of their address. IP addresses are normally written in decimal notation divided by points. The decimal value of each of the four bytes is indicated below using separating points. As an example, the 32-bit IP address in binary notation 11000011.00100010.00001100.00000111 is subsequently written in decimal notation as 195.34.12.7. It goes without saying that, with the constantly increasing number of Internet users, an IP address with a length of just 32 bits is not sufficient to be able to assign a specific individual identifier to every subscriber.

Accordingly, a new version 6 of the Internet protocol standard (IPv6) is being developed, according to which IP addresses include four times the length of a 32-bit IPv4 address, namely 128 bits. As such, in the near future, a specific IP address which is unique and has a one-to-one association will be able to be assigned to every terminal, whether mobile or fixed, for certain periods of time when using the Internet protocol.

This opportunity to allocate to every terminal a specific IP address which can be used to set up a communications link between a number of terminals will allow a user to interchange data between the terminals, which can be a long way apart. However, setting up such a communications link for data transfer will turn out to be an involved process for a user, since he/she currently is not able to store the respective identifiers or IP addresses of the terminals used for data interchange on storage media associated with him/her, such as an SIM (SIM: Subscriber Identity Module) card or another storage medium, and he/she therefore needs to re-enter the respective IP addresses every time.

Accordingly, the present invention is directed toward providing a method and an apparatus which allow a communications link to be set up between two terminals in a simple manner.

### SUMMARY OF THE INVENTION

An inventive method for setting up a communications link between a first terminal, which is connected to a network or communications network based on an Internet protocol, and a second terminal, which is connected to the network based on an Internet protocol and has a specific IP address, involves first transferring the IP address of the second terminal from a storage medium to the first terminal. In this case, the storage medium, particularly in the form of a portable storage medium, can be connected to the first terminal, and the IP address of the second terminal can be read from the storage medium. In addition, the transferred or read IP address is used to set up a communications link from the first terminal to the second terminal over the network based on an Internet protocol.

In accordance with one aspect of the present invention, a storage medium which is particularly suitable for implementing the inventive method includes a memory device for storing one or more IP addresses for terminals which can be connected to a network based on an Internet protocol. In accordance with one advantageous refinement, the storage medium can be in the form of an intelligent memory card. Such a memory card can be inserted into a communications unit or subscriber terminal and removed therefrom without any great involvement, which allows easy access to the identifiers or IP addresses, stored in the memory card, of other terminals. In this case, the intelligent memory card or “smart card” provided can be an SIM card or a UICC (UICC: Universal Integrated Circuit Card) with a USIM (USIM: UMTS Subscriber Identity Module) application. Since these memory cards are conventionally intended to be inserted into a mobile telephone, they have no known storage capability for an IP address for a terminal which can be connected to a network based on an Internet protocol.

However, one advantage when using such memory cards is that an SIM card or UICC card can always be used in every single telephone based on the GSM (Global System for Mobile Communications) or UMTS (Universal Mobile Telecommunication Service) standard. That is to say, a data format used for storing an IP address and a mechanism for retrieving these data are understood by every single GSM or UMTS telephone with IP capability, irrespective of a particular manufacturer, since the data formats and retrieval conditions have been standardized for SIM and USIM/UICC.

According to the GSM standard, the intelligent memory cards provided for implementing the inventive method are referred to as SIM cards, with UMTS making a distinction between the physically available card UICC and its logical function called USIM. In this case, an IP address is stored in an SIM card or in the USIM application on a UICC card. Second-generation mobile communications services, such as those based on the GSM standard, and third-generation mobile communications services, such as those based on the UMTS standard, use precisely specified intelligent cards (smart cards) in addition to the mobile telephones themselves. Once inserted into a mobile telephone, these smart cards allow a user to use a communications service with which he/she is registered. In addition, it is already possible today to store user-specific information, such as the user's telephone number (MSISDN: Mobile Station ISDN Number), a user telephone book, etc., on a smart card. To this extent, the already existing infrastructure of subscriber terminals is extended, on the basis of the present invention, such that any subscriber terminal reads an IP address stored on a smart card for another terminal, which can be connected to a network based on an Internet protocol, and can use this IP address to set up a communications link in a simple manner.

In this case, the communications link can be used such that data are transferred between the terminals, particularly software can be downloaded from one unit to the other, or else such that a terminal is remotely controlled or managed from another terminal (by “remote login” or “remote control”).

The inventive method can be implemented by an apparatus or a terminal which can be connected to a network based on an Internet protocol. In this case, the terminal has a reading device for reading the IP address, stored on the storage medium, of a further terminal, which also can be connected to a network based on an Internet protocol, and a communications device for setting up a communications link to the further terminal using the IP address which has been read.

In accordance with one advantageous embodiment, the terminal has a writing device for storing an IP address on the storage medium. In this case, either the IP address of the terminal itself or the IP address of another terminal to which a communications link needs to be set up can be stored. In this context, an IP address can be entered manually by a user in advance using an input device which is connected to the terminal or is integrated in it, and then can be stored on the storage medium automatically or upon instruction by a user. Secondly, particularly in the case in which the IP address of the terminal itself needs to be stored on the storage medium, the IP address of the terminal itself can be automatically stored on the storage medium which is currently connected to the terminal. To this end, the terminal has, in accordance with one advantageous refinement, a checking device which checks whether an IP address can be stored on the storage medium currently connected to the terminal. If the result of the check is positive, then the terminal's IP address, which is stored in a nonvolatile memory in the terminal, for example, is transferred to the storage medium using the writing device. It is also conceivable, however, in the event of the result of the check being positive (i.e., when an IP address can be stored on the storage medium), for the checking device to ask a user, such as via a display or the like, for confirmation to perform automatic storage of the IP address.

Terminals, particularly for implementing the inventive method, which can be connected to a network based on an Internet protocol can, by way of example, be in the form of a mobile telephone, a wired telephone, a fixed computer or a portable computer or a PDA (PDA: Personal Digital Assistant).

Additional features and advantages of the present invention are described in, and will be apparent from, the following Detailed Description of the Invention and the Figures.

### BRIEF DESCRIPTION OF THE FIGURES

FIG. 1 shows a schematic illustration of four terminals connected to one another over a network based on an Internet protocol.

FIG. 2 shows a schematic illustration of the memory structure on an intelligent memory card for storing IP addresses for terminals.

### DETAILED DESCRIPTION OF THE INVENTION

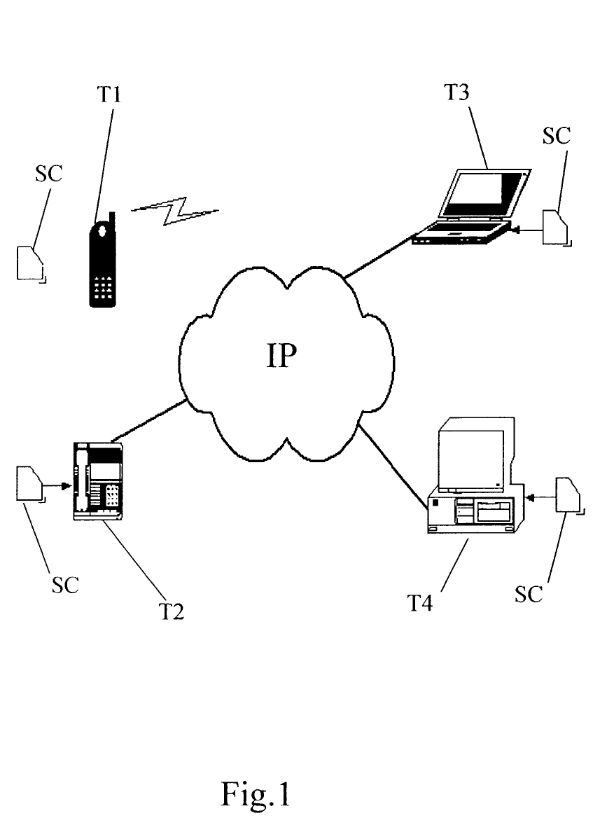

To explain the inventive method for setting up a communications link, and also to explain the apparatuses for implementing the method, reference first will be made to FIG. 1.

FIG. 1 shows four different terminals, namely a mobile radio terminal or mobile telephone T1, a wired telephone T2, a portable computer in the form of a notebook T3, and a fixed computer T4, which are connected to one another over a terminal-specific network, such as a mobile radio network for the mobile telephone (identified by the symbol [symbol] ), a LAN (LAN: Local Area Network) for the computers, etc. (identified by a connection via a solid line) using a network IP based on an Internet protocol, such as the Internet. Using version 6 of the Internet protocol standard (IPv6), all the terminals can have their own static IP address, which is unique or specific to each terminal. By way of example, the respective terminals T1 to T4 can have the following IP addresses:

| | |
|---|---|
| T1: | FEDC:BA98:7654:3210:FEDC:BA98:7654:3210 |
| T2: | FEDC:BA98:7654:3210:FEDC:BA98:7654:3211 |
| T3: | FEDC:BA98:7654:3210:FEDC:BA98:7654:3212 |
| T4: | FEDC:BA98:7654:3210:FEDC:BA98:7654:3214 |

It is assumed that, as expected for the future, each terminal has a device for holding an intelligent memory card or smart card SC, such as an SIM card or a USIM application on the UICC, or that a respective terminal is connected to a reading device for reading such smart cards SC. In this example, a smart card can be inserted into the terminal T1, into the terminal T2 and into the terminal T3, and the terminal T4 has a reading device for inserting the smart card.

Before it is possible to carry out the inventive method for setting up a communications link, a user first needs to store the IP addresses of the terminals he/she uses on his/her smart card SC. One option for doing this is for the user to use one of the terminals which has an input device, such as a keyboard, to enter the IP addresses manually, and then to store these IP addresses on the smart card SC using a writing device provided on the terminal. Alternatively, it is also conceivable for a respective terminal to have a checking device which checks whether a smart card SC connected to the respective terminal is able to store IP addresses for terminals. For this purpose, it is advantageous if the card is able to indicate its ability to store IP addresses for a terminal. After the checking device acknowledges the ability of the smart card SC to store IP addresses for terminals on it, the checking device uses a writing device to store the IP address of the terminal on the smart card SC. Preferably, following acknowledgement of the storage capability of the smart card SC, the checking device can ask the user, such as via a suitable display, whether or not he/she would like to store the IP address of the terminal on the smart card SC.

Once the IP addresses of the user's various terminals have been stored on the smart card, they can be used by any of the user's terminals to address another terminal or to set up a communications link thereto; for example, for the purpose of remote login, remote control or in order to provide information/data on a specific terminal. It is pointed out that the inventive principle is not the sending of some or other messages, calls, instructions or other data to another user, but rather explicitly addressing or talking to a specific terminal/apparatus.

The text below will now explain a use of the inventive method in accordance with a first embodiment. In this case, it is assumed that a user is currently at a conference in Washington, USA and has taken his/her portable computer in the form of a notebook T3 along to this conference. When the user is at the conference in the USA, he/she notices that he/she needs a specific piece of software which is on a fixed office computer T4 in Munich, Germany. To get to the specific piece of software, the user needs to log into the office computer in Munich remotely. To this end, the user inserts the smart card SC storing all the IP addresses of his terminals into the notebook T4, where the stored IP addresses are read. The user's IP addresses which are read in are advantageously shown on a display in the form of a menu list from which the user can finally select the IP address of the fixed office computer T4. To facilitate selection of the IP address or of the terminal associated therewith, it is advantageous if, besides or instead of the IP address of a terminal, a (short) name for the associated terminal is stored on the smart card SC or, by way of example, in a terminal's nonvolatile memory. Once the user has selected the IP address of the target terminal, the terminal connected to the smart card SC, in this case the notebook T3, sets up a communications link to the computer T4. The user is then able to log into the computer T4 remotely and to download the specific piece of software required to the notebook T3. In this way, it is a very simple matter for the user to access the required data on another terminal quickly without the user himself/herself needing to know the IP address of the target terminal; in this case, of the computer T4.

At the same conference, the user realizes that he/she needs to listen to the voice mailbox for the wired office telephone T2, which is also in Munich, Germany. To this end, the user removes the smart card SC from the notebook T3 and inserts it into his/her mobile telephone T1. In line with the procedure described above for setting up a communications link, as described for the notebook T3 and the office computer T4, the user can now set up a communications link between the mobile telephone T1 and the wired office telephone T2. When the office telephone T2 has been called using its stored IP address, and a communications link has been set up, the user can finally listen to the mailbox for the telephone T2.

Finally, the user also would like to synchronize the data on his/her mobile telephone T1 with the data on the notebook T3. To this end, the user selects the notebook's IP address, which is currently stored on the smart card SC connected to the mobile telephone T1, and sets up a communications link between the mobile telephone T1 and the notebook T3. The communications link set up in this way can now be used to synchronize the data.

The text below will now explain another use of the inventive method in accordance with a second embodiment. In this context, it is assumed that a user is registered with a messaging service which allocates to the user a message account which is generally user-specific; i.e., independent of apparatus. In this case, the mobile telephone T1, which is a small terminal, may receive a large message including data which are too extensive to be shown on the display of the mobile telephone T1. However, the user has a second terminal which is capable of showing the aforementioned data. The user therefore will take his/her smart card SC containing the IP addresses of his/her other terminals, will connect it to the mobile telephone T1, and will select another terminal, such as the computer T4, in order to set up a communications link thereto. This allows the user to transfer the extensive data from the mobile telephone T1 to the computer T4 in order to be able to observe or process the data in an appropriate manner.

Using the smart card SC with the IP addresses it stores, the user is provided with a high level of convenience, since he/she can access the IP addresses quickly. In addition, the user does not have to concern himself/herself with the IP addresses of the terminals, and does not have to know the various IP addresses.

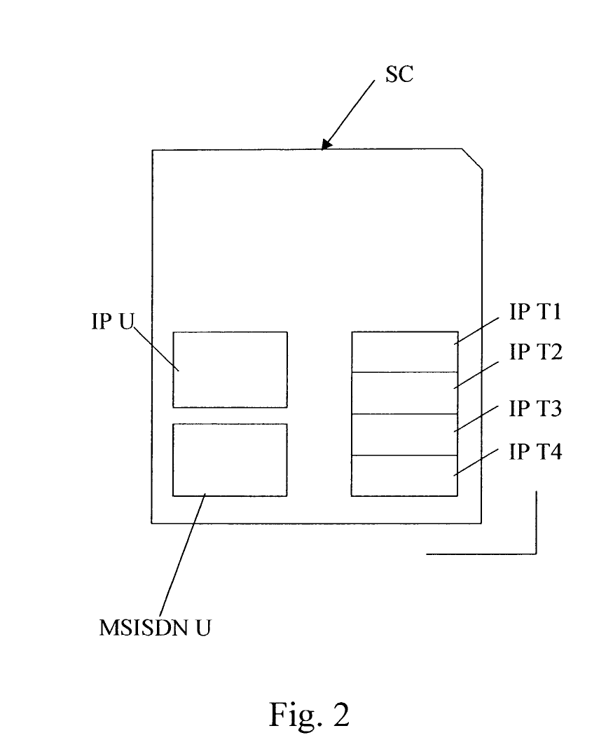

To conclude, reference will now be made to FIG. 2, which illustrates a schematic memory arrangement for storing the IP addresses of the terminals on the smart card SC.

As can be seen in FIG. 2, a user's smart card SC has a number of memory areas for storing user-specific information. Shown by way of example at the bottom right of the smart card SC is a memory block, including the areas IP T1, IP T2, IP T3 and IP T4, which can store the respective IP addresses of the terminals T1, T2, T3 and T4. At the bottom left-hand side of the memory card SC, a memory area MSISDN U is provided which stores the telephone number of the user. Above that, there is a memory area IP U which can store an IP address for a user. This IP address of a user is to be understood to be an IP address which is permanently associated with a user. This IP address is available to a user irrespective of which subscriber terminal or which physical access the user selects for communication.

The document discloses a method for setting up a communications link between a first terminal, which is connected to a network based on an Internet protocol, and a second terminal, which is likewise connected to a network based on an Internet protocol. The method involves connecting a storage medium on which the IP address of the second terminal is stored to the first terminal. The storage medium then reads in the IP address of the second terminal, and finally a communications link is set up from the first terminal to the second terminal over the network using the IP address which has been read. By virtue of the IP addresses of a user's terminals being stored in the storage medium, the user merely needs to insert the storage medium into one of the terminals in order to set up a communications link between two of his/her terminals, the IP address of the further terminal being automatically read out for the communications link without the user needing to remember one of the IP addresses.

Although the present invention has been described with specific embodiments, those skilled in the art will recognize that changes may be made thereto without departing from the spirit and scope of the present invention as set forth in the hereafter appended claims.

1. A method for setting up a communications link between a first terminal, which is connected to a network based on an Internet protocol, and a second terminal, which also is connected to the network based on an Internet protocol and has a specific IP address, the method comprising the steps of:
transferring the IP address of the second terminal from a storage medium to the first terminal; and
setting up a communications link from the first terminal to the second terminal over the network using the transferred IP address.

2. A method for setting up a communications link as claimed in claim 1, the method further comprising the step of transferring data between the first terminal and the second terminal.

3. A method for setting up a communications link as claimed in claim 1, the method further comprising the step of remotely logging into the second terminal from the first terminal.

4. A method for setting up a communications link as claimed in claim 1, the method further comprising the step of remotely controlling the second terminal from the first terminal.

5. A method for setting up a communications link as claimed in claim 1, wherein the storage medium is an intelligent memory card.

6. A method for setting up a communications link as claimed in claim 5, wherein the memory card is one of an SIM card, a UICC card with a USIM application, and a multimedia card.

7. A storage medium for a terminal which can be connected to a network based on an Internet protocol, the storage medium comprising a memory device for storing at least one IP address for the terminal, wherein the IP address is transferred from the storage medium to a further terminal, which is also connected to the network based on an Internet protocol, and a communications link is set up from the terminal to the further terminal over the network using the transferred IP address.

8. A storage medium as claimed in claim 7, wherein the storage medium is an intelligent memory card.

9. A storage medium as claimed in claim 8, wherein the memory card is one of an SIM card, a UICC card with a USIM application, and a multimedia card.

10. A storage medium as claimed in claim 7, wherein the IP address is an address based on an IPv6 protocol.

11. A terminal which can be connected to a network based on an Internet protocol, comprising:
a reading device for reading an IP address stored on a storage medium of a further terminal which also can be connected to the network based on an Internet protocol; and
a communications device for setting up a communications link to the further terminal using the IP address which has been read.

12. A terminal as claimed in claim 11, further comprising a writing device for storing an IP address on the storage medium.

13. A terminal as claimed in claim 11, further comprising an input device for a user to enter an IP address manually.

14. A terminal as claimed in claim 11, further comprising a checking device for checking whether the storage medium can store an IP address, and for automatically storing the IP address if the IP address can be stored on the storage medium.

15. A terminal as claimed in claim 11, wherein the terminal is one of a fixed computer, a portable computer, a mobile telephone and a wired telephone.
